(19) United States
(12) Patent Application Publication
(10) Pub. No.: US 2017/0357678 A1
(43) Pub. Date: Dec. 14, 2017

(54) Internet Map Macro Marker Management Theory and Control System

(71) Applicants: Qiang Wang, San Jose, CA (US); Jin Wang, San Jose, CA (US); Xinwei Wang, San Jose, CA (US)

(72) Inventors: Qiang Wang, San Jose, CA (US); Jin Wang, LangFang (CN); Xinwei Wang, San Jose, CA (US)

(73) Assignees: Qiang Wang, San Jose, CA (US); Jin Wang, San Jose, CA (US); Jin Wang, San Jose, CA (US)

(21) Appl. No.: 15/664,152

(22) Filed: Jul. 31, 2017

(51) Int. Cl. G06F 17/30; G06F 17/24; G06Q 10/10

(52) U.S. Cl. CPC G06F 17/30339; G06F 17/245; G06Q 10/10

(57) ABSTRACT

Now in this busy world, users heavily rely on the internet to browse over the internet map such as Google map, Mapquest map, Baidu map, QQmap, Gaode map, Soho map etc to find and identify the targets users interested through different markers, the Markers on internet maps are first windows or first doors to enter into internet world to get contact with business entities or business service providers,

But so far there is no theory, no system, no way and no approach to differentiate these numerous different kinds of markers or to provide a solution to let users manipulate and control the various markers on the internet map to classify and clarify numerous markers displayed on the internet map after searching, especially in business bustling areas in the metropolis such as New York, London, Tokyo, Hong Kong, Singapore, Shanghai and Beijing etc. Furthermore, there are a lot of markers that have same latitude/same longitude and all markers overlapped each other and user cannot differentiate each others, for example, in one building with same latitude/same longitude on Google map, there are 10 different companies which each of them occupies a different room with different number or suite number in this building, all maps cannot distinguish each of these 10 companies, and on Google map, we can only see ONE marker which is appeared in last, If users want to know details of each company's information, no way.

So the necessity and feasibility of classification and recognition of all these overlapped markers come to the stage and become possible.

Our invention is to propose an approach and a methodology to solve these kind of issues, further more, we propose a theory to let user manipulate the markers on the internet map with some rules to follow.

Our invention is generic and can be used in any internet map on both PC browsers (such as internet explorer, firefox etc) and smartphone for any internet maps such as Google MAp, Baidu Map, Gaode Map, QQ Map and Soho Map etc.

Our invention is designed in Android system but can be applicable for Apple IOs system also.

Our Android App successfully implements these methodology and concepts, we deployed and tested our Android app in all android smart phone successfully already.

Our invention can let users do followings:

1. Classify different kinds of markers on the internet map

2. Manipulate all different kinds of markers on the internet map

3. Manipulation Operations include:

[1]. Add markers onto the internet map

[2]. Remove markers from the internet map

[3]. Distinguish all different markers on the internet map without any confusion

[4]. Perform all these operation from any markers on the internet map

Our solution and methodology can let users pinpoint to the main targeted markers without diluting their focus and distracted from concerned target by other trivia, unimportant and unrelated markers, users can concentrate on specific area, special marker group, specific markers without any confusion and distraction by just simple operation invented here, so our invention provides a clear, concise and clean internet map instead of messed up ones.

From now on we just use Lat or lat stands for Latitude and Lng or Ing stands for Longitude, ie

Lat/lat=Latitude;

Lng/Ing=Longitude.

We also use all markers for all icons/markers, we use maps for all internet maps .

We will disclose our invention as follows step by step.

### TECHNICAL FIELD

The present invention relates generally to any internet map application such as Google Map, MapQuest, Baidu Map, QQ MAp, Gaode Map and Soho map etc. It provides a more detailed approach or method to let any users control, manipulate and operate on the markers in the internet maps for both computer web applications and smartphone apps. This invention creates a series of new concepts to cover a variety range of different types of markers. It provides a great convenience for all end users who use all internet maps as their tools.

### BACKGROUND

The markers on the internet map application such as Google Map etc. are commonly icons used to represent any or almost all entities such as business companies, building, street, houses, etc, all markers on the internet have some basic properties such as:

A. icon: to represent what it is to attract users' attention by graphic symbols.

B. Coordinates, ie. Latitude and Longitude in GPS

C. Address such as 1234 Washington square, some street, SomeCity, Some State, Some Country

D. Some maps also provides basic information for the entities such as Google Map Such as Telephone No, Customer feed back, rating etc. in the markers

But so far, all Internet Maps did not have any approach to go further more to provide more detailed information for all entities such as markers with Same Coordinates Same Addresses (ie several business entities reside in same rooms in same building) and markers with Same Coordinates Different Addresses (i.e. several business entities reside in same building but spread in several different rooms or different levels), further more, in all Internet maps, all markers cannot be controlled or manipulated or operated by the end users in both PC web browser or smartphones. The users can ONLY see what the internet maps provides to them, if user wants to know within some certain area, how many business entities it has, what type they are and manipulate on any or some or all of these entities to get better clarity, it is impossible.

So our invention thoroughly solves this issue, our theory and approach successfully solve this problems.

### SUMMARY

Present invention, the Internet Map Macro Marker Management Theory and Control System, concerns the manipulation and operations on the numerous markers on the internet maps with various browsers while user searching in both computers and smartphones.

The current status for the markers on the internet maps is no control, no rules, no manipulations and no operation for any markers, there is no map or smartphone apps you can add or remove any markers at your will, there is no way or approach to solve the problems to distinguish same coordinates same address, same coordinates different address issues, no way to split whole map into Cartesian coordinate system and put the control on each quadrants to let user focus on specific area and to narrow down to small area so user can easily identify their target with clear clarification.

So our invention is a way to propose a methodology to propose and implement the theory and concepts we defined and solve all these issues.

All users use internet maps daily to browse their targets such as shopping mall, restaurants, places to visit, driving route etc., so in all these activities, markers on the maps play extremely critical roles, but so far until now, all markers are static, ie cannot be operated or manipulated by users, users cannot add any markers, cannot remove any marker, cannot clear any markers in any area they want even though the maps were crowded with huge number of useless markers to distract their attention.

Our invention is purely dynamic solution.

Our invention thoroughly solves these issues. Now all markers on the internet maps are under users' control fully without any problems.

### SPECIFICATIONS AND DEFINITIONS

1. Quadrants/Areas in Internet Map

Quadrants are defined as parts of specified areas in the internet map within specified radius. We just split or separate the circled area evenly as four equal parts, same as Cartesian coordinate system, the purpose of the separation of the circle is to make classification and identification simpler and let markers be easily manipulated.

2. Same Coordinate Same Address Group Marker (SCSAGM);

is the marker to represent the markers that all have Same Coordinate & same address, here same coordinate means same latitude and same longitude, for example:

There are 5 companies (company A, B, C, D and E) that use same building with same latitude and same longitude as follows in Google map

{lat: 37.321267, lng: −122.8327083},

They have same address as: 1234 king Road, San Jose, Calif. 95122 etc., in this case, these markers can be identified as Same Coordinate & same address group marker, please see following FIG. 2 for this concept:

3. Same Coordinate Different Address Group Marker (SCDAGM);

is the marker to represent the markers that all have Same Coordinate but different address, here same coordinate means same latitude and same longitude, for example:

There are 5 companies (company A, B, C, D and E) use same building with same latitude and same longitude as follows in Google map {lat: 37.321267, lng: −122.8327083},

They have different address as:

Company A: 1234 king Road room#1, San Jose, Calif. 95122

Company B: 1234 king Road room#2, San Jose, Calif. 95122

Company C: 1234 king Road room#3, San Jose, Calif. 95122

Company D: 1234 king Road room#4, San Jose, Calif. 95122

Company E: 1234 king Road room#5, San Jose, Calif. 95122

etc, in this case, these markers can be identified as Same Coordinate Different Address Group Marker; please see following FIG. 3 for this concept:

You can see in FIG. 3 above, here number 3 means that there are 3 entities in this marker location, all 3 entities have same coordinates but all have different address listed in following entity table 303:

4. Different Coordinate Same Address Group Marker (DCSAGM);

is the marker to represent the markers that all have different Coordinate but same address, here different coordinate means different latitude and different longitude, for example:

There are 5 companies (company A, B, C, D and E) use same building with same address but different latitude and different longitude as follows:

Company A:
Address: 1234 king Road, San Jose, Calif. 95122
Coordinates in google map {lat: 37.321267, lng: −122.8327083},

Company B:
Address: 1234 king Road, San Jose, Calif. 95122
Coordinates in google map {lat: 37.321259, lng: −122.8327084},

Company C:
Address: 1234 king Road, San Jose, Calif. 95122
Coordinates in google map {lat: 37.321263, lng: −122.8327079},

Company D:
Address: 1234 king Road, San Jose, Calif. 95122
Coordinates in google map {lat: 37.321272, lng: −122.8327078},

Company E:
Address: 1234 king Road, San Jose, Calif. 95122
Coordinates in google map {lat: 37.321275, lng: −122.8327080},

Etc., in this case, these markers can be identified as Different Coordinate Same Address Group Marker;

Different Coordinate Same Address Group Marker is an ease case and can be easily found in many examples in Google map and in our invention, we did not spend more time on this case.

5. Different Coordinate Different Address Group Marker (DCDAGM);

is the marker to represent the markers that all have different Coordinate and different address, here different coordinate means different latitude and different longitude, for example:

There are 5 companies (company A, B, C, D and E) use different building with different address and different latitude and different longitude as follows:

Company A:
Address: 1234 king Road Room#1, San Jose, Calif. 95122
Coordinates in google map {lat: 37.321267, lng: −122.8327083},

Company B:
Address: 1234 king Road Room#2, San Jose, Calif. 95122
Coordinates in google map {lat: 37.321259, lng: −122.8327084},

Company C:
Address: 1234 king Road Room#3, San Jose, Calif. 95122
Coordinates in google map {lat: 37.321263, lng: −122.8327079},

Company D:
Address: 1234 king Road Room#4, San Jose, Calif. 95122
Coordinates in Google map {lat: 37.321272, lng: −122.8327078},

Company E:
Address: 1234 king Road Room#5, San Jose, Calif. 95122
Coordinates in Google map {lat: 37.321275, lng: −122.8327080},

Etc., in this case, these markers can be identified as Different Coordinate Different Address Group Marker;

These are most commonly used markers in all internet maps.

Different Coordinate Different Address Group Marker is also an ease case and can be easily found examples in Google map and in our invention.

6. Quadrant/Area Group Marker (QAGM)

It is the marker to represent the markers which fall in 4 different areas within specified quadrants for specified radius respectively. The number on the marker stands for total number of entities in this area. This is our invention to create this marker to display, monitor and control the markers in each quadrant in the map.

these markers can be identified as Quadrant/Area Group Marker (QAGM);

These are not markers used before in all internet maps but invented and created by us.

Advantage of these quadrant control markers is that they can be used to monitor and control all markers within their quadrants/areas. Quadrant/Area Group Marker provides a concise, clean and clear operation and solution to let user to make manipulation on internet markers. Please see FIG. 4: Quadrant/Area Group Marker for this concept.

In FIG. 6, with specified radius 1 mile, one circle was drawn and 4 Cartesian coordinate quadrants were created, each area is defined as Quadrant or Area on the internet map. Here we can see four different Quadrant/Area Group Markers on the circle:

Quadrant Group marker 1 has No 6; ie in quadrant 1, there are 6 entities/markers

Quadrant Group marker 2 has No 88; ie in quadrant 2, there are 88 entities/markers

Quadrant Group marker 3 has No 9; ie in quadrant 3, there are 6 entities/markers

Quadrant Group marker 4 has No 84; ie in quadrant 4, there are 84 entities/markers

7. Center Master Group Marker (CMGM);

is the marker to represent the markers that are spread in all 4 different areas/quadrants for specified radius. The number on the CMGM marker stands for total number of entities in this whole area. This is our invention to create this marker to display, monitor and control the markers in all 4 quadrants in the map.

This unique marker can be identified as Center Master Group Marker;

Advantage of Center Master Group Marker is that they can be used to monitor and control all markers within all quadrants/areas by entity table associated with it. Center Master Group Marker provides a concise, clean and clear operation and solution to let user to make manipulation on internet markers through entity table. Different from other 4 Quadrant/Area group markers, this marker can provide a outline of all markers in circled area instead of separated ones, so with simple glance, users can easily find how many total entities/companies they circled within specified radius such as 1,2,3,5 or 10 miles.

Please see FIG. 7: Center Master Group Marker (CMGM) for this concept.

8. General Common Marker (GCM);

is the marker to represent each of the individual entities circled within specified radius on the internet map. They are not SCSAGM and SCDAGM markers, It is original marker, It is also most popular markers used on internet so far.

9. Entity:

is business entity to represent a company, a shop or similar item on the internet map;

10. Entity Table;

is a table with some columns and rows to list all business entities and their attributes or properties such as business type, addresses, company name, contact information etc with some criteria selected by user, it is associated with each markers on the map;

The Entity Table creation is used to manipulate all markers on the map, with this Entity Table, user can easily make any operation toward the markers on the internet map.

Each row in the Entity Table is one marker;

Each Column in the Entity Table is one property of the marker;

The Entity Table is the core of the invention to manipulate the markers on the internet maps.

11. Internet Map Macro Marker Management Theory and Control System;

a theory can be summarized as follows:

A. all markers on the internet maps can be manipulated and controlled

B. markers control and manipulation means that they can be added or removed upon users requests

C. Markers control and manipulation are implemented through the entity tables associated with each marker.

D. The entity tables are core part of this theory and system, each row in the entity tables represents One marker or One business Entity, Each Columns in the entity tables represents one of the properties of the marker or the business Entity

E. Marker Management Theory and Control System uses select one, a few of or some and all entities in the table to put 1 or some or all markers on the specific area in the internet map, it uses clear button to clear all markers in specific areas or all areas

F. Marker control and manipulation need some Auxiliary Markers to complete the implementation;

G. Auxiliary Markers are defined as Center Master Group Marker (CMGM), p Quadrant/Area Group Markers (QAGM) etc.;

### IMPLEMENTATION

In the internet map search with specified radius such as 1, 2, 3, 4, 5 or 10 miles in the Android Application initiated and created by us, the circle will round up all entities within this radius, then the markers we created above will be used to perform following operations:

1. Quadrants/Areas in internet Map will be created, whole circle will be split into four equal quadrants, the separation and naming convention are all same as Cartesian coordinates system.

2. Same Coordinate Same Address Group Markers Basic Operations:
A. Same Coordinate Same Address Group Markers will be displayed once map search found the markers met the condition, software programs designed in the android app will calculate all LatLng of each items in the queries then group them into “Same Coordinate Same Address Group Markers”;
B. Once “Same Coordinate Same Address Group Markers” were created, the numbers of entities in this group will be displayed on the marker on the internet map.
C. Once “Same Coordinate Same Address Group Markers” were clicked, the numbers of entities in this group will be displayed in another popup window dialogue box in a table format as follows and see FIG. 6: Table lists all entities contained within the marker.
D. Vertical scroll bar in the entity table can be used to scroll down and up to search any entities in the table.
E. Horizontal scroll bar in the entity table can be used to scroll left and right to display all columns of the entities in the table.
F. Exit button, check all button, Uncheck all button in the table can be used to select all or uncheck any entities in the table and confirm selection/uncheck.
G. Manual selection is available to select 1 or a few or all or any entities in the table.
H. All selected entity's markers will be displayed on the map after exit button pressed.
I. All entity's markers in the map will be remove if “ClearAll” button was pressed.

3. Same Coordinate Different Address Group Marker Basic Operations;
Almost same as above section: “2. Same Coordinate Same Address Group Markers Basic Operations:” and Implementation is same as normal markers associated with entity table

4. Quadrant/Area Group Marker (QAGM) Basic Operations;
Some more buttons added into this marker's Entity Table:
Button 1: confirm: same as above 2 and 3
Button 2: ClearAll: same as above 2 and 3
Button 3: UncheckAll: same as above 2 and 3
New Buttons:
Button 4: ClearArea: clear all markers in this quadrant or area
Button 5: ShowArea: display all markers in this quadrant or area.
Please see FIG. 12: Control buttons in the Entity Table for Quadrant/Area Group Marker. (QAGM).
Basic operation of the QAGM markers are:
A. Quadrant/Area Control Group Marker will be displayed once map draws the circle on the map;
B. Once “Quadrant/Area Control Group Marker” is created on the circle, the numbers of entities in this quadrant will be displayed on the marker on the internet map.
C. Once “Quadrant/Area Control Group Marker” were clicked, the numbers of entities in this group will be displayed in another popup window dialogue box in a table format as follows and see FIG. 9: Control buttons in the Table for Quadrant Marker (Continued).
D. Once “ClearArea” button was clicked, the markers in this quadrant will be cleared or removed immediately on the map.
E. Once “ShowArea” button was clicked, the markers in this quadrant will be added immediately on the map.

7. Center Master Group Marker (CMGM);
Almost same as Section 6 but new items added as follows:
Old buttons:
Button 1: Confirm: same as above 2 and 3
Button 2: CheckAll: same as above 2 and 3.
Button 3: UncheckAll: same as above 2 and 3
New Buttons:
Button 4: ClearAll: clear all markers in all quadrants.
Button 5: ShowAll: display all markers in all quadrants.
Please see FIG. 13: Control buttons in the Table for Center Master Group Marker (CMGM).

### BRIEF DESCRIPTION OF VIEW OF DRAWINGS IN THE INVENTION

FIG. 1: Quadrant/Area concepts.

FIG. 2: Same Coordinate & Same Address Group Marker (SCSAGM)

FIG. 3: Same Coordinate Different Address Group Marker (SCDAGM)

FIG. 4: Details of Different Coordinate Same Address Group Marker (DCSAGM)

FIG. 5: Different Coordinate Different Address Marker (DCDAM)

FIG. 6:Quadrant/Area Group Marker (QAGM)

FIG. 7: Center Master Control Group Marker (CMGM).

FIG. 8: General Common Marker (GCM).

FIG. 9: Concept of Entity

FIG. 10: Entity Table lists all entities contained within the marker.

FIG. 11: Entities in the Entity Table for Same Coordinates Different Address Group Markers (SCDMGM).

FIG. 12:Control buttons in the Entity Table for Quadrant/Area Group Marker (QAGM).

FIG. 13: Control buttons in the Table for Center Master Group Marker (CMGM)

FIG. 14: Control buttons in the Table for Center Master Group Marker, Entities were selected.

FIG. 15: The flow chart of Internet Map Macro Marker Management Theory and Control System.

### DETAILED DESCRIPTION OF VIEW OF DRAWINGS IN THE INVENTION

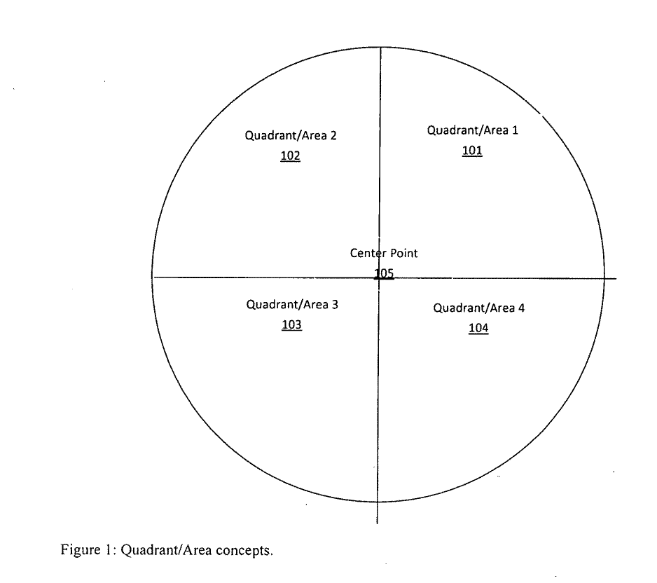

FIG. 1: Quadrant/Area concepts.

FIG. 1 is described as Quadrant/Area concepts same as Cartesian coordinate system, all quadrants have same size of area, Quadrants are defined as parts of specified areas in the internet map within specified radius. We just split or separate the circled area evenly as 4 parts, exactly same as Cartesian coordinate system, The purpose of the separation of the circle is to make classification and identification simpler and let markers be easily manipulated. Please see following FIG. 1 for quadrant concept:

101 Quadrant/Area 1 is same as Quadrant 1 in Cartesian coordinate system;

102 Quadrant/Area 2 is same as Quadrant 2 in Cartesian coordinate system;

103 Quadrant/Area 3 is same as Quadrant 3 in Cartesian coordinate system;

104 Quadrant/Area 4 is same as Quadrant 4 in Cartesian coordinate system;

105 current location or center point is the center to draw the circle;

We use markers with associated Latitude and Longitude to locate their positions

If the distance of a marker with latitude/longitude to the center point's latitude/longitude is less than selected radius and meet following condition:

Case 1: markers within 101 Quadrant/Area 1, they must meet:
A. marker's Lat>=center point's Lat
B. marker's Lng>=center point's Lng

Then this marker falls in 102 Quadrant/Area 2;

Case 2: markers within 102 Quadrant/Area 2, they must meet:
A. marker's Lat>=center point's Lat
B. marker's Lng<center point's Lng

Then this marker falls in 102 Quadrant/Area 2;

Case 3: markers within 103 Quadrant/Area 3, they must meet:
A. marker's Lat<center point's Lat
B. marker's Lng<center point's Lng

Then this marker falls in 103 Quadrant/Area 3;

Case 4: markers within 104 Quadrant/Area 4, they must meet:
A. marker's Lat<center point's Lat
B. marker's Lng>center point's Lng

Then this marker falls in 104 Quadrant/Area 4;

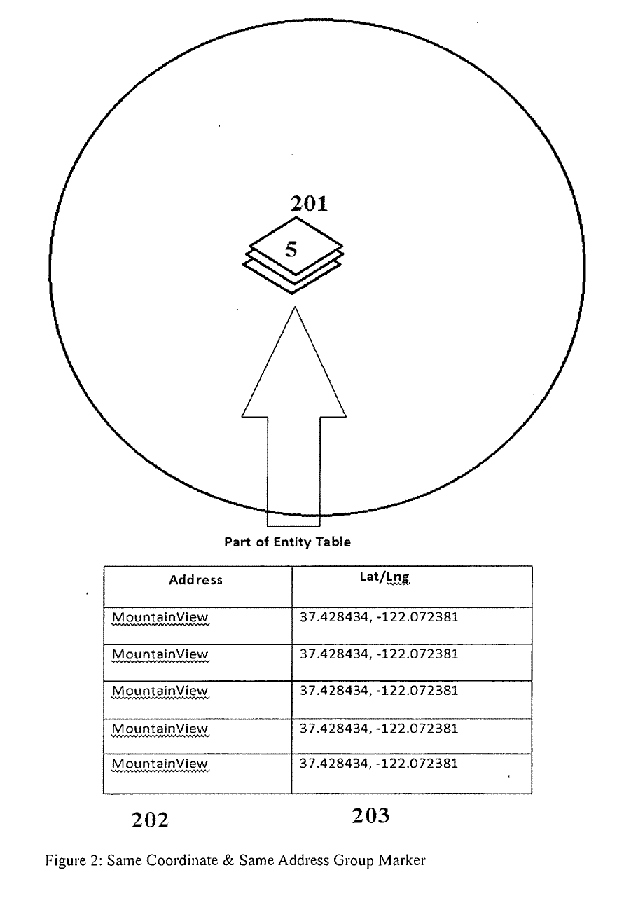

FIG. 2: Same Coordinate & Same Address Group Marker (SCSAGM)

FIG. 2 is described as the markers with Same Coordinate Same Address Group Marker (SCSAGM), 201 is the marker to indicate that in this marker, it represents 5 business entities that all have same latitude/longitude and same addresses with different entity names.

202 is the column that all 5 markers contained in the entity table have Same Address;

203 is the column that all 5 markers contained in the entity table have Same Coordinates or Lat/Lng;

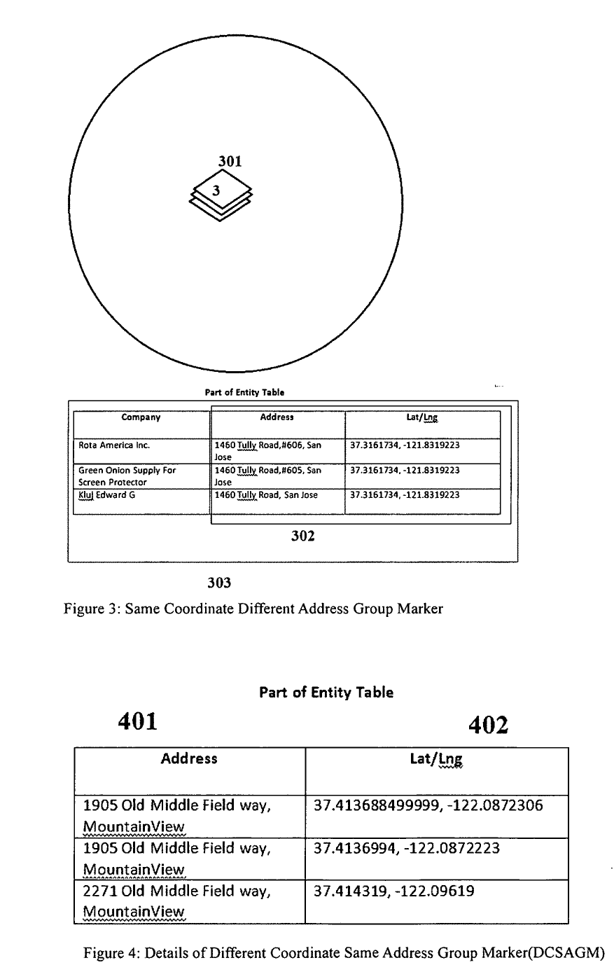

FIG. 3: Same Coordinate Different Address Group Marker

FIG. 3 is described as the markers with Same Coordinate Different Address Group Marker,

301 is the marker to indicate in this marker, the number 3 represents 3 business entities that all have same latitude/longitude but different addresses, difference are different entities' names and addresses.

302 is the part of entity table associated with this marker, which has 2 columns: Address and LatLng it lists 3 business entities that all have same latitude/longitude but different addresses, difference are different entities' names and addresses. Each row is ONE entity and each column is properties of entities, from 302, we can see addresses are different but latitude/longitudes are same

303 is detailed part of the entity table, which has 3 columns: Company, Address and LatLng and 3 rows to represent 3 business entities with company names as Rota America, Green Onions Supply For Screen Protector and Kluj Edward G respectively.

FIG. 4: Details of Different Coordinate Same Address Group Marker (DCSAGM)

401 is the column that the entities have same address

402 is the column that the entities have different Coordinates (Lat/Lng)

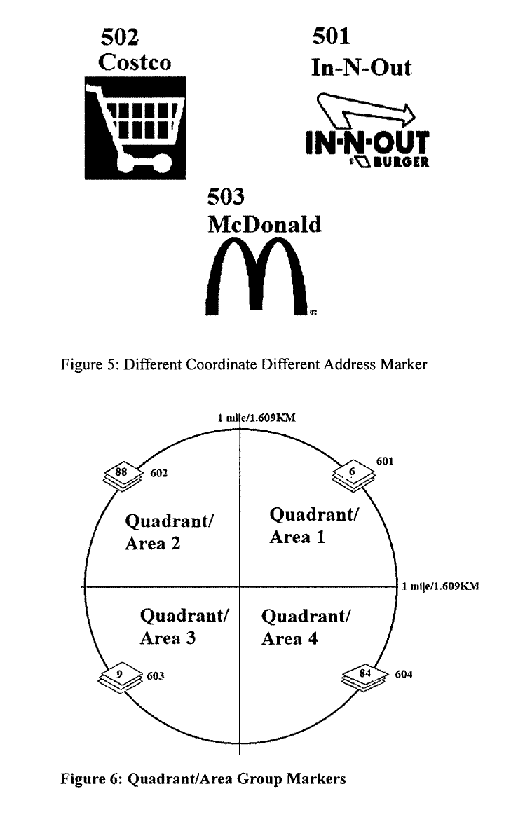

FIG. 5: Different Coordinate Different Address Marker (DCDAM)

It is most popular used marker in the internet map,

501 is the marker of In-N-Out restaurant,

502 is the marker of Costco Wholesale store,

503 is the marker of McDonald fast food, Etc.

FIG. 6: Quadrant/Area Group Marker (QAGM)

is described as Quadrant/Area Group Markers,

For specified radius 1 mile, one circle was drawn and 4 Cartesian coordinate quadrants were created, each area is defined as Quadrant or Area on the internet map. Here we can see four different Quadrant/Area Group Markers on the circle,

601 is Quadrant Group marker 1 and it has number 6 of various markers within this area;

602 is Quadrant Group marker 2 and it has number 88 of various markers within this area;

603 is Quadrant Group marker 3 and it has number 9 of various markers within this area;

604 is Quadrant Group marker 4 and it has number 84 of various markers within this area;

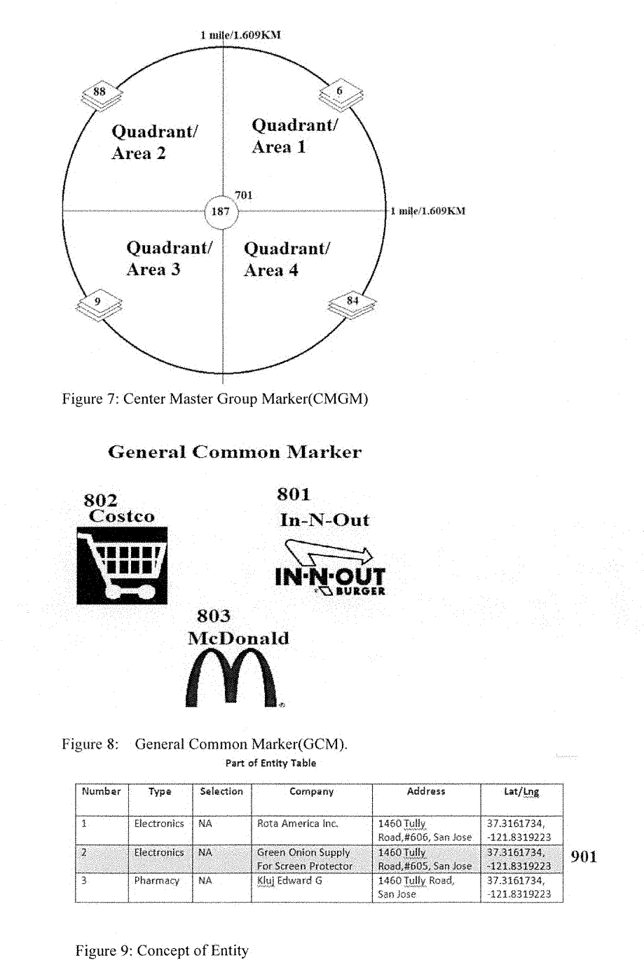

FIG. 7: Center Master Control Group Marker (CMGM)

It is described as Center Master Group Marker (CMGM),

For specified radius 1 mile, within the circle drawn, 701 is CMGM marker and it has number of 187 various markers within this whole area (including all four/4 quadrants/areas);

CMGM marker can let user to control all markers at top level layer, instead of stepping into each marker's deep layer.

FIG. 8: General Common Marker (GCM).

It is same as Different Coordinate Different Address Marker (DCDAM)

It is most popular used marker in the internet map,

801 is the marker of In-N-Out restaurant,

802 is the marker of Costco wholesale store,

803 is the marker of McDonald fast food, Etc.

FIG. 9: Concept of Entity

901 is the row (grayed out) in the entity table that represents ONE business entity on the internet map. Each entity has many properties such as name, type, address, phone, website etc.

Each property in the entities represents One Column in the entity table.

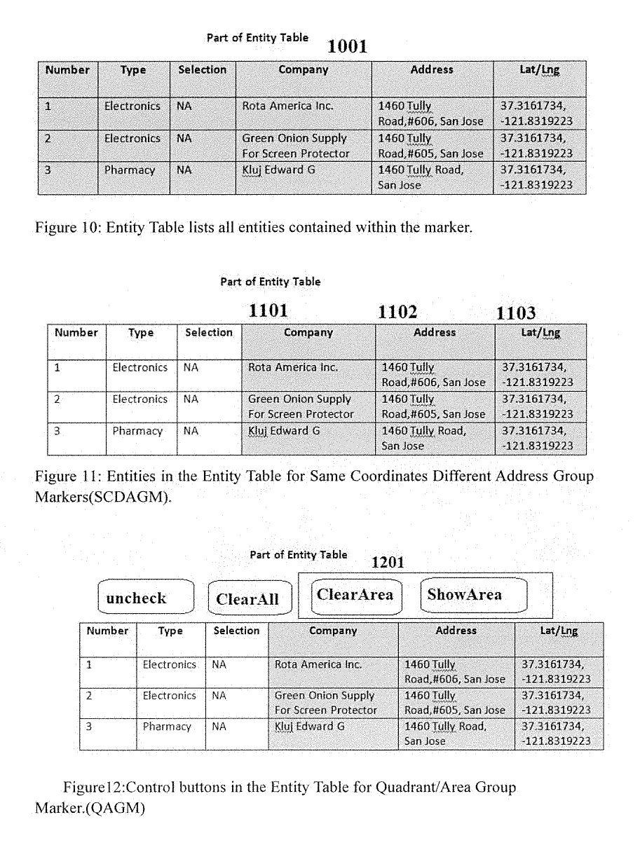

FIG. 10: Entity Table lists all entities contained within the marker.

It is described as the Entity Table that contains all entities;

Item 1001 indicates that the Entity Table can be manipulate as:

A. all markers have their own Entity Table associated with them, there are 3 different markers belong to 2 types of following:
a. General Common Markers (GCM),
b. SCDAGM markers

B. Same kinds of markers have same type of the Entity Table structures, different kinds of markers have different type of the Entity Table structures,

C. Different types of the Entity Table structures mean that the Entity Tables may have different columns and different numbers of rows and different control buttons.

all markers have their own Entity Tables associated with them.

D. Vertical scroll bar in the entity table can be used to scroll down and up to search any entities in the entity table.

E. Horizontal scroll bar in the entity table can be used to scroll left and right to display all columns of the entities in the entity table.

F. Exit button, check all button, Uncheck all button etc. in the table can be used to select all or uncheck any entities in the table and confirm selection/uncheck.

G. Manual selection is available to select 1 or a few or all or any entities in the table

H. All selected entity's markers will be displayed on the map after confirm button pressed.

FIG. 11: Entities in the Entity Table for Same Coordinates Different Address Group Markers (SCDMGM).

1101 shows different company names,

1102 shows different Address but

1103 shows same coordinates

FIG. 12: Control buttons in the Entity Table for Quadrant/Area Group Marker (QAGM). They are the Control buttons in the Entity Table for Quadrant Marker.

1201 has 2 more buttons: 1 is ClearArea and 1 is ShowArea,

ClearArea clears all markers in current area/quadrants, if now it is in Quadrant 1, so markers in Quadrant 1 will be removed. All markers in Quadrant 2, Quadrant 3 and Quadrant 4 still remain untouched.

Same thing, if ShowArea button pressed, only markers in Quadrant 1 will be displayed on the map, other areas untouched.

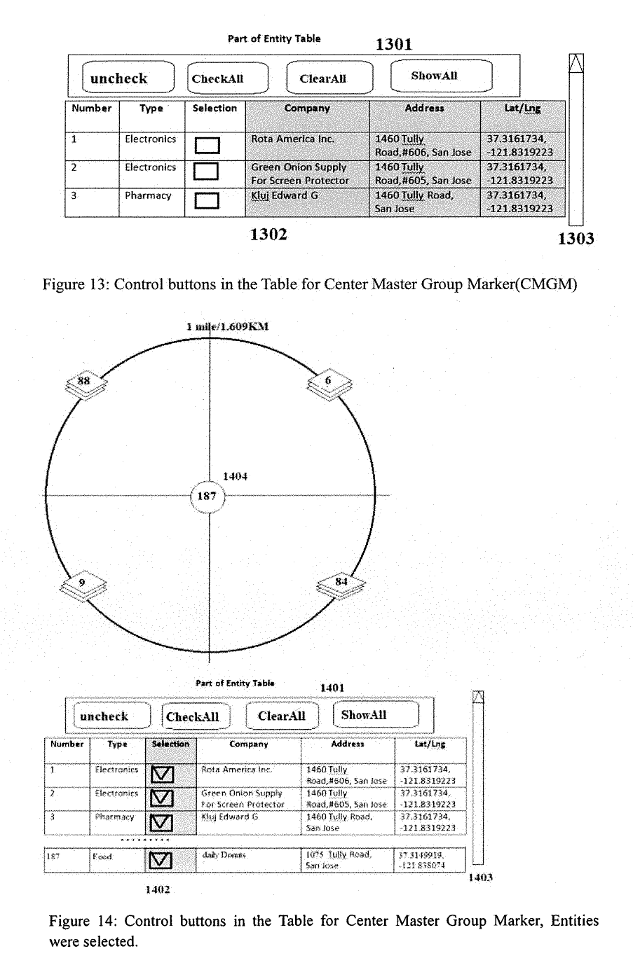

FIG. 13: Control buttons in the Table for Center Master Group Marker (CMGM)

1301 shows all new control buttons in the entity table;

1302 shows part of the entity table associated with the Center Master Group Marker,

1303 is vertical scroll bar to see whole entity table

FIG. 14: Control buttons in the Table for Center Master Group Marker, Entities were selected.

FIG. 14 shows all entities once CheckAll pressed and all markers in the entity table will be added onto maps.

1401 represents the control buttons in the entity table.

1402 represents the entities selected in the checkbox, scroll bars can be used to see all other parts in the entity table.

1403 represents the scroll bar in the entity table, it can be used to scroll up and down to view all entities in the entity table

1404 represents the Center Master Group Marker with total number of marker of 187 in circled 1 mile radius

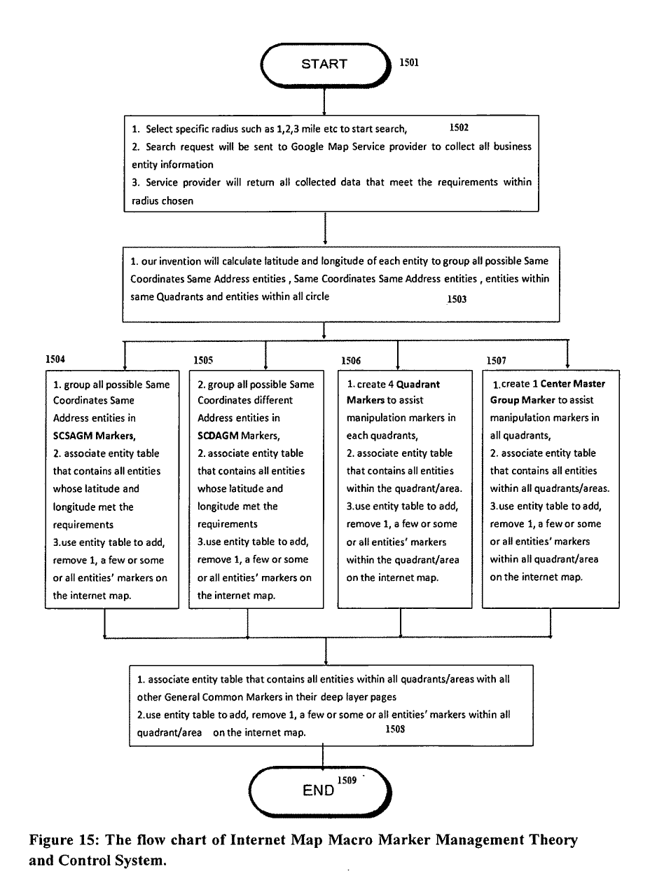

FIG. 15: The flow chart of Internet Map Macro Marker Management Theory and Control System.

It shows the flow chart of Internet Map Macro Marker Management Theory and Control System.

1501 represents the start status, from here, user can prepare to send a request to service provider to get all the entities data back by select proper radius.

1502 represents the users' actual operation from the Android App UI, select specific radius, then send request to service provider, then get data back,

1503 then as per this invention defined rules, all entities data will be classified and grouped into all different kinds of markers and different group.

1504 represents that as per standards set by the theory and invention, some markers are grouped into the Same Coordinate Same Address Group Marker (SCSAGM); then the entity tables are associated with each SCSAGM marker to let user can add/remove any, some or all business entities in the internet map;

1505 represents that as per standards set by the theory and invention, some markers are grouped into the Same Coordinate Different Address Group Marker (SCDAGM); then the entity tables are associated with each SCSAGM marker to let user can add/remove any, some or all business entities in the internet map;

1506 represents that as per standards set by the theory and invention, some markers are grouped into the Quadrant/Area Group Marker (QAGM); then the entity tables are associated with each QAGM marker to let user can add/remove any, some or all business entities in each quadrant/area in the internet map;

1507 represents that as per standards set by the theory and invention, all other markers are defined as Center Master Group Marker (CMGM); then the entity tables are associated with each CMGM marker to let user can add/remove any, some or all business entities in all 4 quadrant/areas in the internet map;

1508 represents that as per standards set by the theory and invention, all other markers are defined as General Common Marker (GCM); then the entity tables are associated with each GCM marker in its deep layer pages to let user can add/remove any, some or all business entities in all 4 quadrant/area in the internet map;

1509 represents the end, all operations done.

What is claimed is:

1. Initiate and implement the concept of
A. Same Coordinates Same Address Group Marker (SCSAGM) to group all markers that meet the conditions of both Same Coordinates Same Address into a more generic marker;
B. Same Coordinates Different Address Group Marker (SCDAGM) to group all markers that meet the conditions with Same Coordinates But Different Address into a more generic marker and put number on this generic marker to represent total number entities/markers in it in Android applications;
C. Quadrant/Area Group Markers (QAGM) to group all markers that meet the conditions with their Lat/Lng Coordinates within respective quadrant/areas, the number on the Quadrant/Area Group Marker represents the numbers of entities in this quadrant/area; There are total 4 Quadrant/Area Group Markers for 4 separate quadrant/area respectively;
D. Center Master Group Markers (CMGM) to group all markers that meet the conditions with their Lat/Lng Coordinates within all 4 quadrant/areas within specific radius, the number on the CMGM Marker represents the numbers of entities in this all 4 quadrant/areas within the circle; CMGM Marker is top level controller of all markers on the map.
E. General Common Markers (GCM) are the markers that displayed on the internet maps, our invention also associate all GCM markers with whole list of entity Table when their Lat/Lng Coordinates within specific radius. GCM are most popular markers shown on the internet maps.

2. Initiate and implement the entity table to associate with all following markers to list and display all entities within the certain areas and to
A associate each Same Coordinates Same Address Group Markers (SCSAGM) with the Entity Table to list all entities' details to let user can have full control over the entities in this generic marker; table's row is dynamic and row number depends on the number of items,
B. associate each Same Coordinates Different Address Group Markers (SCDAGM) with the entity Table to list all entities' details to let user can have full control over the entities in this generic marker; table's row is dynamic and row number depends on the number of items,
C. associate each Quadrant/Area Group Markers (QAGM) with the entity Table to list all entities' details within its quadrant/area to let user can have full control over the entities in the marker in this area; table's row is dynamic & row number depends on the number of items in the area,
D. associate each General Common Markers (GCM) with the entity Table to list all entities' details to let user can have full control over the entities in this original marker; the table's row is dynamic and row number depends on the No. of items,
E. associate Center Master Group Marker (CMGM) with the entity Table to list all entities' details to let user can have full control over the entities in this generic marker; the table's row is dynamic and row number depends on the number of items,

3. For the claim 2, User can use all kinds of the entity tables to
A. add any number of markers from the entity table onto Map,
B. remove all number of markers from the entity table onto Map,
C. add some number of markers from the entity table onto Map,
D. add all number of markers from the entity table onto Map,

4. In the entity table associated with generic marker, it is comprising of Columns of
A. Number: total number in the marker
B. Marker Type: indicate entity belongs to which business type, such as food store, shopping mall, auto shop, restaurant, pharmacy etc
C. Selection: let user make any or all number of entities selection from the table listed entities
D. Name: business name of each entities in the table
E. Address: business address of each entities in the table
F. LatLng: business Latitude and Longitude of each entities in the table I.e. One column represents one property of the business entities
Business entities can have many properties such as name, address, GPS Coordinates, Telephone No, website url etc.
In this way, user can have a clear outline for each entity in the table and have a clear overall picture for all entities in the map.
Through this entity table of the generic marker, user can manipulate all markers on the map.

5. For the claim 4,The entity table associated with all markers is comprising of the rows of all entities in specified area, i.e. One row represents one business entity,
